(19) United States
(12) Patent Application Publication
(10) Pub. No.: US 2019/0159481 A1
(43) Pub. Date: May 30, 2019

(54) Solid Drink for Keeping Balanced Constitution and Processing Method Thereof

(71) Applicant: Zhonghua CI, Beijing (CN)

(72) Inventor: Zhonghua CI, Beijing (CN)

(21) Appl. No.: 15/877,928

(22) Filed: Jan. 23, 2018

(30) Foreign Application Priority Data
Nov. 30, 2017 (CN) 201711244167.2

(51) Int. Cl. A23L 2/02; A23L 2/60; A23L 29/212; A23P 30/00

(52) U.S. Cl. CPC A23L 2/02; A23L 2/60; A23V 2002/00; A23P 30/00; A23L 29/212

(57) ABSTRACT

Provided is a solid drink for keeping balanced constitution. The solid drink includes the following components of raw materials in parts by weight: mulberry 24-58, ginkgo 10-30, lily 30-51, gorgon euryale seeds 30-50, Chinese yam 29-49, semen sesami nigrums 31-48, dried orange peel 15-35, dextrin 37-70, maltodextrin 15-39, soluble starch 17-40, and aspartame 0.1-0.25. The solid drink is easy to manufacture, and all the raw materials used are medicine materials of medicinal and edible dual purposes, and all the excipients used also satisfy national standard GB2760-2011 (National Food Safety Standard for Uses of Food Additives). It is safe to eat (drink) and suitable for long-term consumption, with certain effects in keeping balanced constitution. Moreover, the processing process is suitable for industrial mass production.

### CROSS-REFERENCE TO RELATED APPLICATIONS

This application claims priority under 35 U.S.C. § 119 to a Chinese Patent Application No. 201711244167.2 filed Nov. 30, 2017, in the State Intellectual Property Office of China, the entire contents of which are hereby incorporated by reference.

### TECHNICAL FIELD

The present invention relates to the field of health food, and particularly to a solid drink for keeping balanced constitution and a processing method thereof.

### BACKGROUND

According to “Classification and Determination of Constitution in TCM” by China Association of Traditional Chinese Medicine, the constitution of human bodies includes nine types, namely, balanced constitution (constitution of yin-yang harmony), yang-deficiency constitution, yin-deficiency constitution, qi (vital energy)-deficiency constitution, phlegm-dampness (tanshi) constitution, dampness-heat constitution, qi-stagnation constitution, blood-stasis constitution, and allergic (special, tebing) constitution. Most of them belong to sub-health status.

The balanced constitution is such a constitution status mainly featured by moderate posture, rosy facial complexion, vigorousness, healthy and robust functions and states of internal organs (zang and fu), also called as “mild constitution”. The population with balanced constitution occupies about 32.75%. More men than women have the balanced constitution, moreover, the number of people having the balanced constitution get decreased with the increasing age.

People having the balanced constitution have a well-proportioned, healthy and strong body configuration, easygoing and optimistic personality, moisturizing and lustrous facial complexion and skin color, dense and glossy hairs, bright eyes, bright and lubricating nose color, acute sense of smell, normal sense of taste, ruddy lip color, vigorousness, indefatigability, cold-resistance and heat-resistance, sound sleep, good appetite, regular defecation, reddish tongue color, thin and white tongue fur, gentle pulse, less illness, and strong adaptability to natural environments and social environments.

Food is the best for preventing diseases and keeping healthy for human beings. “Homology between medicine and food” is one of the most valuable contributions of original Chinese medical science to the human beings. According to “Rites of Zhouli⋅Tianguan⋅Curing sickness”, curing diseases by combining five tastes, five cereals, and five medicines, which indicates the physiological health-care function of food. A method of regulating organism using properties of food to get healthy or cure diseases is called as food therapy (nutrition therapy, dietary therapy). However, “nourishment” is better than “therapy”. Dietary nourishment refers to nourishing by combining nutritional effects of food with the physical condition of the body to enhance resistibility and immunity, and further to prolong life and have a strong physique. According to “Qian Jin Prescriptions”, a doctor should firstly know the source of a disease and symptoms, then treat the disease with corresponding food. If the disease cannot be cured through food therapy, then a medicine is used. It can be seen that the application of food therapy is not only the basic treatment means of doctors at that time, but also an important ground for evaluating whether a doctor has excellent medical skills.

It is proposed in “Huangdi Neijing” that “making preventive treatment before getting illness is the top-class medical skill, performing treatment when illness is suspected is the middle-class medical skill, and performing treatment when illness is present is the lower-class medical skill”. “Making preventive treatment before getting illness” refers to taking corresponding measures to prevent occurrence and development of illness. The constitution determines our health and susceptibility to diseases. In the face of various diseases, increasingly low morbidity age, and more and more sub-healthy population, the food therapy is favored by more and more consumers due to its advantages of being healthy and natural. With regard to problems easily arising, it is of critical significance to develop a type of food having the function of maintaining good health and keeping balanced constitution with good taste by combining the precious experience of traditional Chinese health care and accumulation of good aspects of keeping the balanced constitution of the traditional Chinese medicine, using technologies and methods of modern sciences, based on the homology between medicine and food.

### DISCLOSURE OF THE INVENTION

A main object of the present invention is to provide a health-care food for keeping balanced constitution.

In order to achieve the above object, according to one aspect of the present invention, a solid drink for keeping balanced constitution is provided.

The solid drink for keeping balanced constitution according to the present invention includes the following components of raw materials in parts by weight: mulberry 24-58, ginkgo 10-30, lily 30-51, gorgon euryale seeds 30-50, Chinese yam 29-49, semen sesami nigrums 31-48, dried orange peel 15-35, dextrin 37-70, maltodextrin 15-39, soluble starch 17-40, and aspartame 0.1-0.25.

Furthermore, the solid drink for keeping balanced constitution of the present invention includes the following components of raw materials in parts by weight: mulberry 32-47, ginkgo 15-25, lily 35-45, gorgon euryale seeds 36-47, Chinese yam 34-44, semen sesami nigrums 36-43, dried orange peel 20-30, dextrin 40-60, maltodextrin 20-30, soluble starch 21-33, and aspartame 0.13-0.22.

Furthermore, the solid drink for keeping balanced constitution of the present invention includes the following components of raw materials in parts by weight: mulberry 40, ginkgo 20, lily 40, gorgon euryale seeds 40, Chinese yam 40, semen sesami nigrums 40, dried orange peel 24, dextrin 50, maltodextrin 25, soluble starch 25, and aspartame 0.18.

In order to achieve the above object, according to another aspect of the present invention, a method for processing a solid drink for keeping balanced constitution is provided.

The method for processing a solid drink for keeping balanced constitution according to the present invention includes the following steps:

(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use;

(2) decocting: decocting twice a mixture obtained in step (1) with addition of water, to obtain a Chinese medicine liquid;

(3) concentrating: feeding the Chinese medicine liquid obtained in step (2) into a concentrator via a pipeline, to be concentrated into a thick paste;

(4) wet granulating: mixing and stirring dextrin, maltodextrin, soluble starch, and aspartame to obtain a mixed excipient, and adding the thick paste obtained in step (3) to the mixed excipient, then stirring and granulating them.

Furthermore, operations of the twice decocting processes in the above step (2) are as follows:

for the first time, adding water of 10 times the weight of the mixture obtained in the above step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;

for the second time, adding water of 8 times the weight of the mixture obtained in the above step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction.

Furthermore, the concentration temperature in the above step (3) is 70-80° C., and the relative density of the resulted thick paste is 1.2-1.5 under a temperature condition of 50° C.

Furthermore, the wet granulating in the above step (4) includes the following steps:

(4.1) dry blending: putting dextrin, maltodextrin, soluble starch, and aspartame into an efficient mixing granulator to be mixed and stirred for 15 minutes, to obtain the mixed excipient;

(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time;

(4.3) drying: putting the sized particles obtained in step (4.2) into a boiling dryer to be dried;

(4.4) sizing for the second time: performing the second time of sizing by an oscillating machine.

Furthermore, a 12-mesh screen is used in the first time of sizing, and a 10-mesh screen is used in the second time of sizing.

Furthermore, in the drying process of step (4.3), a temperature of the materials is kept at 70-80° C., and a moisture of the final materials is kept below 5%.

Furthermore, a step of selecting particles is further included after the second time of sizing, to select particles with 10-60 meshes.

The solid drink of the present invention is easy to manufacture, and all the raw materials used are medicine materials of medicinal and edible dual purposes, and all the excipients used also satisfy national standard GB2760-2011 (National Food Safety Standard for Uses of Food Additives). It is safe to eat (drink) with good taste, and suitable for long-term consumption for keeping the balanced constitution. Moreover, the processing process is suitable for industrial mass production.

### BRIEF DESCRIPTION OF DRAWINGS

The figures constituting a portion of the present application are used for further understanding of the present invention, so as to make other features, objects, and advantages of the present application more obvious. Exemplary examples of the present invention, drawings, and description thereof are used to explain the present invention, rather than improperly limiting the present invention. In the figures,

FIG. 1 shows a processing process of a solid drink according to an example of the present invention;

FIG. 2 shows specific steps of wet granulating in a processing process of a solid drink according to an example of the present invention.

### DETAILED DESCRIPTION OF EMBODIMENTS

In order to make a person skilled in the art better understand solutions of the present application, below technical solutions of the examples of the present application will be described clearly and completely in conjunction with figures of the examples of the present application. Apparently, some but not all of examples of the present application are described. Based on the examples of the present application, all the other examples, which a person ordinarily skilled in the art obtains without paying inventive effort, fall within the protection scope of the present application.

Besides, the term “include (comprise)” and any variants thereof are intended to cover non-exclusive containing, for example, a product including a series of raw materials or a method including a series of steps is not necessarily limited to listing those raw materials or steps, but may include other steps or raw materials which are not clearly listed or inherent to the method or product.

It should be indicated that examples of the present application and features in the examples can be combined with each other in the case of no conflict. The present application will be described in detail with reference to the figures in conjunction with the examples.

A main object of the present invention is to provide a health-care food for keeping balanced constitution.

In order to realize the above object, according to one aspect of the present invention, a solid drink for keeping balanced constitution is provided.

The solid drink for keeping balanced constitution according to the present invention includes the following components of raw materials in parts by weight: mulberry 24-58, ginkgo 10-30, lily 30-51, gorgon euryale seeds 30-50, Chinese yam 29-49, semen sesami nigrums 31-48, dried orange peel 15-35, dextrin 37-70, maltodextrin 15-39, soluble starch 17-40, and aspartame 0.1-0.25.

Mulberry: mulberry, cold in nature, and bitter and sour in taste, exerts the curative effect through the heart, liver, and kidney channels, replenishes the blood, nourishes yin, generates the body fluid, and moisturizes dryness, and is used for treatment of vertigo and tinnitus, palpitation and insomnia, premature graying of hair, constipation, body fluid deficiency and thirst, internal heat and consumptive thirst, blood deficiency constipation, liver and kidney tonification, calming down endogenous wind, essential fluid nourishment, and liver-kidney yin deficiency.

Ginkgo: ginkgo, sweet, bitter, and astringent in taste, mild in nature, and slightly toxic, exerts the curative effect through the lung channels, astringes the lungs, relieves asthma, promotes astriction, and arrests leucorrhoea, and is used for treatment of asthma with abundant phlegm, leucorrhoea, gonorrhea, and enuresis and frequent urination.

Lily: lily, sweet in taste and cold in nature, exerts the curative effect through the heart and lung channels, nourishes yin, moistens the lungs, clears away the heart fire, and calms the nerves, and is used for treatment of yin-deficiency dry coughing, overstrained cough and hemoptysis, fidgeting due to deficiency and palpitation, insomnia and dreaminess, and trance.

Gorgon euryale seeds: gorgon euryale seeds, sweet and astringent in taste, and mild in nature, exert the curative effect through the spleen and kidney channels, tonify kidney to strengthen essence, nourish spleen, cure diarrhea, dispel dampness, and arrest leucorrhoea, and are used for treatment of gonobolia and spermatorrhea, enuresis and frequent urination, lung-deficiency chronic diarrhea, gonorrhea, and leucorrhoea.

Chinese yam: Chinese yam, sweet in taste and mild in nature, exerts the curative effect through the spleen, lung, and kidney channels, replenishes the spleens, nourishes the stomach, generates the body fluid, tonifies the lungs, nourishes the kidneys, and astringes essences, and is used for treatment of spleen deficiency, chronic diarrhea, lung deficiency, kidney deficiency, leucorrhoea, and frequent urination.

Semen sesami nigrums: semen sesami nigrums, mild in nature and sweet in taste, exert the curative effect through the liver, lung, and kidney channels, nourish the livers and kidneys, generate the body fluid, lubricate the bowel, moisturize the skin, nurse hairs, and improve the eyesight.

Dried orange peel: dried orange peel, acrid and slightly bitter in taste, and warm in nature, exerts the curative effect through the spleen and lung channels, regulates qi and middle energizer, removes dampness to reduce phlegm, and can be used for treatment of qi stagnation of spleen and stomach, abdominal fullness and distention, vomit, or chest distress, anorexia, and loose stool caused by retention of damp-turbid substance, but should be used with caution for people with yin and body fluid deficiency and excess heat inside.

In the present invention, the above ingredients are combined so that efficacies of the various medicine materials generate a synergistic effect, with the functions of regulating yin and yang and balancing qi and the blood, and can be used for keeping the balanced constitution, so that people are vigorous with strong resistibility, and avoid the occurrence of diseases.

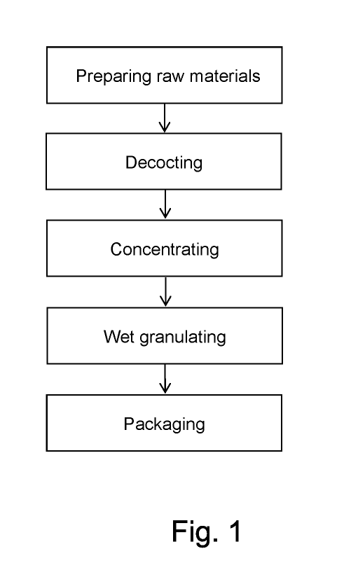

As shown in FIG. 1, a method for processing a solid drink for keeping balanced constitution includes the following steps:

(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use, with proportions of respective raw materials being the proportions provided in the present invention;

(2) decocting: decocting twice a mixture obtained in step (1) with addition of water, to obtain a Chinese medicine liquid;

(3) concentrating: feeding the Chinese medicine liquid obtained in step (2) into a concentrator via a pipeline, to be concentrated into a thick paste;

(4) wet granulating: mixing and stirring dextrin, maltodextrin, soluble starch, and aspartame to obtain a mixed excipient, and adding the thick paste obtained in step (3) to the mixed excipient, then stirring and granulating them;

(5) packaging: subjecting a product obtained after the wet granulating to a packaging step, to result in a finished product.

The object of step (1) is to remove fat from the seed Chinese medicine materials ground with a 2-mesh screen; rhizomatic Chinese medicine materials are rich in cellulose and starch, cutting or grinding them to extract can effectively reserve target ingredients and prevent expansion of polysaccharides; purification can remove impurities and soil, and effectively reduce remnant of pollutants such as heavy metals and pesticides.

Operations of the twice decocting processes in the above step (2) are as follows: for the first time, adding water of 10 times the weight of the mixture obtained in the step (1), heating them for decocting and extracting the same, wherein timing is started when they are boiling, and after 1.5 hours of decoction and extraction, immediately feeding the medicine liquid through a pipeline filter by a pump into a stainless steel medicine liquid tank;

for the second time, adding water of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction.

The concentration temperature in the above step (3) is 70-80° C., and the relative density of the resulted thick paste is 1.2-1.5 under the temperature condition of 50° C. Low-temperature evaporation can effectively reduce decomposition of heat-sensitive components, for example, organic acids such as citric acid, malic acid, and oxalic acid, moreover, it has high concentration efficiency with no discharge of solvent vapor, and facilitates evaporation and airtightness without polluting environment.

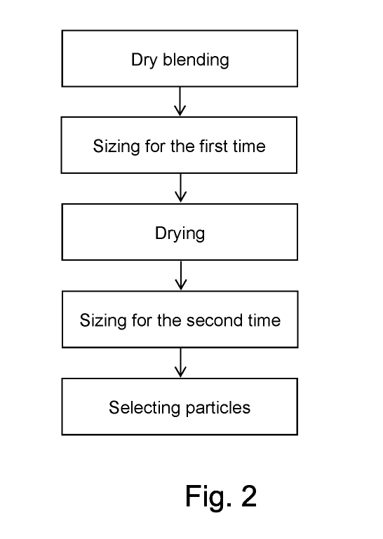

As shown in FIG. 2, the wet granulating in the above step (4) includes the following steps:

(4.1) dry blending: putting dextrin, maltodextrin, soluble starch, and aspartame into an efficient mixing granulator to be mixed and stirred for 15 minutes, to obtain the mixed excipient, with proportions of respective raw materials being the proportions provided in the present invention.

(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time, wherein stirring granulation can preferably prevent separation of various components. Since the segregation phenomenon easily occurs due to differences existing among particle sizes and densities of the components of the mixed extract, the granulation not only can overcome this problem, but also can significantly improve the solubility.

(4.3) drying: putting the sized particles obtained in step (4.2) into a boiling dryer to be dried, wherein the boiling drying can effectively control the particle size distribution, and control the moisture of the product.

(4.4) sizing for the second time: performing the second time of sizing by an oscillating machine, wherein through the second time of sizing, the particles distribution, bulk density, and compactness can be controlled.

In the above steps, a 12-mesh screen is used in the first time of sizing, and a 10-mesh screen is used in the second time of sizing.

In the drying process of the above step (4.3), the temperature of the materials is kept at 70-80° C., and the moisture of the final materials is kept below 5%. In the present step, a pot can be turned frequently according to the drying situation of the materials, ensuring that the moisture of the final materials meets requirements.

On the basis of the above embodiment, a step of selecting particles is further included after the second time of sizing, to select particles with 10-60 meshes. The appearance and homogeneity of the product particles can be improved by selecting the particles. In practical operation, after the particle selection, a product name, a product lot number, specification, net weight, date of manufacture, name of position, and person in charge are recorded and tagged, and a delivery receipt is filled in, then the product is transferred to an intermediate station.

### Example 1

A solid drink for keeping balanced constitution included the following components of raw materials in parts by weight: mulberry 24, ginkgo 10, lily 30, gorgon euryale seeds 30, Chinese yam 29, semen sesami nigrums 31, dried orange peel 15, dextrin 37, maltodextrin 15, soluble starch 17, and aspartame 0.1.

A preparing method was as follows:

(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use;

(2) decocting: decocting twice a mixture obtained in step (1) with addition of water, to obtain a Chinese medicine liquid, operations of the twice decocting processes being as follows:

for the first time, adding water of 10 times the weight of the mixture obtained in the step (1), heating them for decocting and extracting the same, wherein timing was started when they were boiling, and after 1.5 hours of decoction and extraction, immediately feeding the medicine liquid through a pipeline filter by a pump into a stainless steel medicine liquid tank;

for the second time, adding water of 8 times the weight of the mixture obtained in the step (1), heating them for decocting and extracting the same, wherein timing was started when they were boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction;

(3) concentrating: feeding the Chinese medicine liquid obtained in step (2) into a concentrator via a pipeline, to be concentrated into a thick paste, the concentration temperature being 70° C., and the relative density of the resulted thick paste being 1.2 under the temperature condition of 50° C.;

(4) wet granulating:

(4.1) dry blending: putting dextrin, maltodextrin, soluble starch, and aspartame into an efficient mixing granulator to be mixed and stirred for 15 minutes, to obtain a mixed excipient;

(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time with a 12-mesh screen;

(4.3) drying: putting the sized particles obtained in step (4.2) into a boiling dryer to be dried, the temperature of the materials being kept at 70° C., and the moisture of the final materials being kept at 5%;

(4.4) sizing for the second time: performing the second time of sizing by an oscillating machine with a 10-mesh screen;

(4.5) selecting particles: selecting particles with 10-60 meshes;

(5) packaging: bagging mixed and qualified particles according to standard operation instructions of an automatic packaging machine, wherein packaging appearance and quantity was detected at any time, and the adjustment was made in time in case of abnormalities, closing and storing the packaged particles in a clean container, with a product name, a lot number, quantity, date, etc. being marked for subsequent use, wherein a reference packaging quantity was 8 g per bag, and a packaging quantity limit was 8 g per bag±5%.

### Example 2

A solid drink for keeping balanced constitution included the following components of raw materials in parts by weight: mulberry 58, ginkgo 30, lily 51, gorgon euryale seeds 50, Chinese yam 49, semen sesami nigrums 48, dried orange peel 35, dextrin 70, maltodextrin 39, soluble starch 40, and aspartame 0.25.

A preparing method was as follows:

(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use;

(2) decocting: decocting twice a mixture obtained in step (1) with addition of water, to obtain a Chinese medicine liquid, operations of the twice decocting processes being as follows:

for the first time, adding water of 10 times the weight of the mixture obtained in the step (1), heating them for decocting and extracting the same, wherein timing was started when they were boiling, and after 1.5 hours of decoction and extraction, immediately feeding the medicine liquid through a pipeline filter by a pump into a stainless steel medicine liquid tank;

for the second time, adding water of 8 times the weight of the mixture obtained in the step (1), heating them for decocting and extracting the same, wherein timing was started when they were boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction;

(3) concentrating: feeding the Chinese medicine liquid obtained in step (2) into a concentrator via a pipeline, to be concentrated into a thick paste, the concentration temperature being 80° C., and the relative density of the resulted thick paste being 1.5 under the temperature condition of 50° C.;

(4) wet granulating:

(4.1) dry blending: putting dextrin, maltodextrin, soluble starch, and aspartame into an efficient mixing granulator to be mixed and stirred for 15 minutes, to obtain a mixed excipient;

(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time with a 12-mesh screen;

(4.3) drying: putting the sized particles obtained in step (4.2) into a boiling dryer to be dried, the temperature of the materials being kept at 80° C., and the moisture of the final materials being kept at 3%;

(4.4) sizing for the second time: performing the second time of sizing by an oscillating machine with a 10-mesh screen;

(4.5) selecting particles: selecting particles with 10-60 meshes;

(5) packaging: bagging mixed and qualified particles according to standard operation instructions of an automatic packaging machine, wherein packaging appearance and quantity was detected at any time, and the adjustment was made in time in case of abnormalities, closing and storing the packaged particles in a clean container, with a product name, a lot number, quantity, date, etc. being marked for subsequent use, wherein a reference packaging quantity was 8 g per bag, and a packaging quantity limit was 8 g per bag±5%.

### Example 3

A solid drink for keeping balanced constitution included the following components of raw materials in parts by weight: mulberry 32, ginkgo 15, lily 35, gorgon euryale seeds 36, Chinese yam 34, semen sesami nigrums 36, dried orange peel 20, dextrin 40, maltodextrin 20, soluble starch 21, and aspartame 0.13.

A preparing method was as follows:

(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use;

(2) decocting: decocting twice a mixture obtained in step (1) with addition of water, to obtain a Chinese medicine liquid, operations of the twice decocting processes being as follows:

for the first time, adding water of 10 times the weight of the mixture obtained in the step (1), heating them for decocting and extracting the same, wherein timing was started when they were boiling, and after 1.5 hours of decoction and extraction, immediately feeding the medicine liquid through a pipeline filter by a pump into a stainless steel medicine liquid tank;

for the second time, adding water of 8 times the weight of the mixture obtained in the step (1), heating them for decocting and extracting the same, wherein timing was started when they were boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction;

(3) concentrating: feeding the Chinese medicine liquid obtained in step (2) into a concentrator via a pipeline, to be concentrated into a thick paste, the concentration temperature being 75° C., and the relative density of the resulted thick paste being 1.45 under the temperature condition of 50° C.;

(4) wet granulating:

(4.1) dry blending: putting dextrin, maltodextrin, soluble starch, and aspartame into an efficient mixing granulator to be mixed and stirred for 15 minutes, to obtain a mixed excipient;

(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time with a 12-mesh screen;

(4.3) drying: putting the sized particles obtained in step (4.2) into a boiling dryer to be dried, the temperature of the materials being kept at 78° C., and the moisture of the final materials being kept at 3.4%;

(4.4) sizing for the second time: performing the second time of sizing by an oscillating machine with a 10-mesh screen;

(4.5) selecting particles: selecting particles with 10-60 meshes;

(5) packaging: bagging mixed and qualified particles according to standard operation instructions of an automatic packaging machine, wherein packaging appearance and quantity was detected at any time, and the adjustment was made in time in case of abnormalities, closing and storing the packaged particles in a clean container, with a product name, a lot number, quantity, date, etc. being marked for subsequent use, wherein a reference packaging quantity was 8 g per bag, and a packaging quantity limit was 8 g per bag±5%.

### Example 4

A solid drink for keeping balanced constitution included the following components of raw materials in parts by weight: mulberry 47, ginkgo 25, lily 45, gorgon euryale seeds 47, Chinese yam 44, semen sesami nigrums 43, dried orange peel 30, dextrin 60, maltodextrin 30, soluble starch 33, and aspartame 0.22.

A preparing method was as follows:

(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use;

(2) decocting: decocting twice a mixture obtained in step (1) with addition of water, to obtain a Chinese medicine liquid, operations of the twice decocting processes being as follows:

for the first time, adding water of 10 times the weight of the mixture obtained in the step (1), heating them for decocting and extracting the same, wherein timing was started when they were boiling, and after 1.5 hours of decoction and extraction, immediately feeding the medicine liquid through a pipeline filter by a pump into a stainless steel medicine liquid tank;

for the second time, adding water of 8 times the weight of the mixture obtained in the step (1), heating them for decocting and extracting the same, wherein timing was started when they were boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction;

(3) concentrating: feeding the Chinese medicine liquid obtained in step (2) into a concentrator via a pipeline, to be concentrated into a thick paste, the concentration temperature being 73° C., and the relative density of the resulted thick paste being 1.33 under the temperature condition of 50° C.;

(4) wet granulating:

(4.1) dry blending: putting dextrin, maltodextrin, soluble starch, and aspartame into an efficient mixing granulator to be mixed and stirred for 15 minutes, to obtain a mixed excipient;

(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time with a 12-mesh screen;

(4.3) drying: putting the sized particles obtained in step (4.2) into a boiling dryer to be dried, the temperature of the materials being kept at 72° C., and the moisture of the final materials being kept at 4.5%;

(4.4) sizing for the second time: performing the second time of sizing by an oscillating machine with a 10-mesh screen;

(4.5) selecting particles: selecting particles with 10-60 meshes;

(5) packaging: bagging mixed and qualified particles according to standard operation instructions of an automatic packaging machine, wherein packaging appearance and quantity was detected at any time, and the adjustment was made in time in case of abnormalities, closing and storing the packaged particles in a clean container, with a product name, a lot number, quantity, date, etc. being marked for subsequent use, wherein a reference packaging quantity was 8 g per bag, and a packaging quantity limit was 8 g per bag±5%.

### Example 5

A solid drink for keeping balanced constitution included the following components of raw materials in parts by weight: mulberry 40, ginkgo 20, lily 40, gorgon euryale seeds 40, Chinese yam 40, semen sesami nigrums 40, dried orange peel 24, dextrin 50, maltodextrin 25, soluble starch 25, and aspartame 0.18.

A preparing method was as follows:

(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use;

(2) decocting: decocting twice a mixture obtained in step (1) with addition of water, to obtain a Chinese medicine liquid, operations of the twice decocting processes being as follows:

for the first time, adding water of 10 times the weight of the mixture obtained in the step (1), heating them for decocting and extracting the same, wherein timing was started when they were boiling, and after 1.5 hours of decoction and extraction, immediately feeding the medicine liquid through a pipeline filter by a pump into a stainless steel medicine liquid tank;

for the second time, adding water of 8 times the weight of the mixture obtained in the step (1), heating them for decocting and extracting the same, wherein timing was started when they were boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction;

(3) concentrating: feeding the Chinese medicine liquid obtained in step (2) into a concentrator via a pipeline, to be concentrated into a thick paste, the concentration temperature being 77° C., and the relative density of the resulted thick paste being 1.4 under the temperature condition of 50° C.;

(4) wet granulating:

(4.1) dry blending: putting dextrin, maltodextrin, soluble starch, and aspartame into an efficient mixing granulator to be mixed and stirred for 15 minutes, to obtain a mixed excipient;

(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time with a 12-mesh screen;

(4.3) drying: putting the sized particles obtained in step (4.2) into a boiling dryer to be dried, the temperature of the materials being kept at 76° C., and the moisture of the final materials being kept at 3.8%;

(4.4) sizing for the second time: performing the second time of sizing by an oscillating machine with a 10-mesh screen;

(4.5) selecting particles: selecting particles with 10-60 meshes;

(5) packaging: bagging mixed and qualified particles according to standard operation instructions of an automatic packaging machine, wherein packaging appearance and quantity was detected at any time, and the adjustment was made in time in case of abnormalities, closing and storing the packaged particles in a clean container, with a product name, a lot number, quantity, date, etc. being marked for subsequent use, wherein a reference packaging quantity was 8 g per bag, and a packaging quantity limit was 8 g per bag±5%.

### Experiment Example 1: Sensory Evaluation

The solid drink prepared in Examples 1 to 5 was mixed with boiling water and then taken as test groups, and the mixed medicine liquid after the two times of decoction prepared and obtained in step (2) in the processing process of Example 5 as a control group. Samples of the test groups and the control group were set to have three repetitions. 20 professional sensory evaluators performed the sensory evaluation. The sensory evaluating and scoring standards are shown in Table 1, and the sensory evaluating results are shown in Table 2.

TABLE 1
Sensory Evaluating and Scoring Standards

| Item | Sensory Evaluation | Score |
|---|---|---|
| Color | dark | 1 |
| | suitable | 5 |
| | light | 1 |
| Odor | strong Chinese medicine | 1 |
| | smell | |
| | slight Chinese medicine | 3 |
| | smell | |
| | medicine fragrance | 5 |
| | relatively light | 3 |
| | light | 1 |
| Taste | bitter | 1 |
| | relatively bitter | 3 |
| | fragrant and sweet | 5 |
| | relatively sweet | 3 |
| | too sweet | 1 |
| Smoothness | smooth and lubricated | 5 |
| | sense of particles | 3 |
| | sense of scratching | 1 |
| | throat | |
| | hard to swallow | 0 |
| Overall | bad | — |
| Evaluation | ordinary | — |
| | good | — |

TABLE 2
Sensory Evaluating Results

| | | | Test Groups | | | | | |
|---|---|---|---|---|---|---|---|---|
| | | Control | Example | Example | Example | Example | Example | |
| Item | | Group | 1 | 2 | 3 | 4 | 5 | Mean |
| Sensory | Color | 26 | 94 | 93 | 93 | 96 | 94 | 94 |
| Evaluation | Odor | 33 | 91 | 97 | 94 | 93 | 93 | 93.6 |
| (score) | Taste | 21 | 95 | 94 | 92 | 91 | 92 | 92.8 |
| | Smoothness | 89 | 92 | 92 | 93 | 95 | 91 | 92.6 |
| | Mean | 42.25 | 93 | 94 | 93 | 93.75 | 92.5 | |
| Overall | Good | 3 | 19 | 20 | 18 | 20 | 19 | 19.2 |
| Evaluation | Ordinary | 9 | 1 | 0 | 2 | 0 | 1 | 0.8 |
| (person-time) | Bad | 8 | 0 | 0 | 0 | 0 | 0 | 0 |

It can be seen from the above test results that the mean scores of the color, odor, taste, and smoothness of the solid drink prepared in Examples 1 to 5 evaluated by the 20 professional sensory evaluators are higher than the scores of the control group. The results show that the solid drink provided in the present invention is greatly improved in the odor and taste over the medicine liquid obtained after decocting a Chinese medicine decoction piece, moreover, the sweet taste is added, and the taste and the smoothness are both substantially improved, quite suitable for daily drinking.

The foregoing only describes preferred examples of the present invention and is not intended to limit the present invention. For a person skilled in the art, various modifications and variations may be made to the present invention. Any modifications, equivalent replacements, improvements, etc., made within the spirit and principle of the present invention, should be covered by the protection scope of the present invention.

What is claimed is:

1. A solid drink for keeping balanced constitution, comprising the following components of raw materials in parts by weight: mulberry 24-58, ginkgo 10-30, lily 30-51, gorgon euryale seeds 30-50, Chinese yam 29-49, semen sesami nigrums 31-48, dried orange peel 15-35, dextrin 37-70, maltodextrin 15-39, soluble starch 17-40, and aspartame 0.1-0.25.

2. The solid drink for keeping balanced constitution of claim 1, comprising the following components of raw materials in parts by weight: mulberry 32-47, ginkgo 15-25, lily 35-45, gorgon euryale seeds 36-47, Chinese yam 34-44, semen sesami nigrums 36-43, dried orange peel 20-30, dextrin 40-60, maltodextrin 20-30, soluble starch 21-33, and aspartame 0.13-0.22.

3. The solid drink for keeping balanced constitution of claim 1, comprising the following components of raw materials in parts by weight: mulberry 40, ginkgo 20, lily 40, gorgon euryale seeds 40, Chinese yam 40, semen sesami nigrums 40, dried orange peel 24, dextrin 50, maltodextrin 25, soluble starch 25, and aspartame 0.18.

4. A method for processing a solid drink for keeping balanced constitution, comprising the following steps:
(1) preparing raw materials: mixing Chinese yam, mulberry, lily, gorgon euryale seeds, semen sesami nigrums, dried orange peel, and ginkgo having undergone purification, cleansing, cutting, and grinding, for subsequent use;
(2) decocting: decocting twice a mixture obtained in step (1) with addition of water, to obtain a Chinese medicine liquid;
(3) concentrating: feeding the Chinese medicine liquid obtained in step (2) into a concentrator via a pipeline, to be concentrated into a thick paste;
(4) wet granulating: mixing and stirring dextrin, maltodextrin, soluble starch, and aspartame to obtain a mixed excipient, and adding the thick paste obtained in step (3) to the mixed excipient, then stirring and granulating them.

5. The method for processing a solid drink for keeping balanced constitution of claim 4, wherein operations of the twice decocting processes in the step (2) are as follows:
for the first time, adding water of 10 times the weight of the mixture obtained in the step (1), heating them for decocting and extracting the same, wherein timing is started when they are boiling, and after 1.5 hours of decoction and extraction, immediately feeding a medicine liquid through a pipeline filter by a pump into a stainless steel medicine liquid tank;
for the second time, adding water of 8 times the weight of the mixture obtained in the step (1), heating them for decocting and extracting the same, wherein timing is started when they are boiling, and after 1.5 hours of decoction and extraction, immediately feeding the medicine liquid through the pipeline filter by the pump into the stainless steel medicine liquid tank, and mixing it evenly with the medicine liquid obtained from the first time of decoction and extraction.

6. The method for processing a solid drink for keeping balanced constitution of claim 4, wherein a concentration temperature in the step (3) is 70-80° C., and a relative density of the resulted thick paste is 1.2-1.5 under a temperature condition of 50° C.

7. The method for processing a solid drink for keeping balanced constitution of claim 4, wherein the wet granulating in the step (4) comprises the following steps:
(4.1) dry blending: putting dextrin, maltodextrin, soluble starch, and aspartame into an efficient mixing granulator to be mixed and stirred for 15 minutes, to obtain the mixed excipient;
(4.2) sizing for the first time: adding the thick paste extracted in step (3) gradually to the mixed excipient, mixing and stirring the thick paste at cutting speed I and stirring speed I to granulate them to obtain a soft material, and sizing the soft material for the first time;
(4.3) drying: putting the sized particles obtained in step (4.2) into a boiling dryer to be dried;
(4.4) sizing for the second time: performing the second time of sizing by an oscillating machine.

8. The method for processing a solid drink for keeping balanced constitution of claim 7, wherein a 12-mesh screen is used in the first time of sizing, and a 10-mesh screen is used in the second time of sizing.

9. The method for processing a solid drink for keeping balanced constitution of claim 7, wherein in the drying process of step (4.3), a temperature of materials is kept at 70-80° C., and a moisture of final materials is kept below 5%.

10. The method for processing a solid drink for keeping balanced constitution of claim 7, wherein a step of selecting particles is further comprised after the second time of sizing, to select particles with 10-60 meshes.
